(19) United States
(12) Patent Application Publication
(10) Pub. No.: US 2026/0208741 A1
(43) Pub. Date: Jul. 23, 2026

(54) METHOD AND APPARATUS FOR MOVING MASS ESTIMATION BASED ON ENERGY BALANCE

(71) Applicant: Cummins Inc., Columbus, IN (US)

(72) Inventors: Yusuf M. Poonawala, Pune (IN); Pradheepram Ottikkutti, Erie, PA (US); Chandan Nene, Pune (IN)

(73) Assignee: Cummins Inc., Columbus, IN (US)

(21) Appl. No.: 19/140,288

(22) PCT Filed: Dec. 20, 2023
(86) PCT No.: PCT/US2023/085211

§ 371 Date: Jun. 17, 2025

(30) Foreign Application Priority Data
Dec. 21, 2022 (IN) 202241074147

(51) Int. Cl. B60W 30/188; B60W 10/04; B60W 30/18; B60W 40/13; B60W 50/00

(52) U.S. Cl. CPC B60W 30/188; B60W 10/04; B60W 30/18109; B60W 40/13; B60W 2050/0004; B60W 2520/00; B60W 2710/0666; B60W 2710/083

(57) ABSTRACT

Systems and methods for determining a value regarding a system, such as a vehicle, to enable control of the system are provided. A method includes: receiving an indication of a transmission being in a continuously single setting; receiving an indication of a brake event of the vehicle; determining a first energy value regarding the vehicle based on the transmission being in the continuously single setting and the indication of the brake event; receiving an indication of a change in operation of at least one of the transmission and the brake event; determining a second energy value regarding the vehicle based on the indication of the change in operation of the at least one of the transmission and the brake event; based on the first and second energy values, determining a value regarding the vehicle; and controlling operation of a component of the vehicle based on the determined value.

### CROSS-REFERENCE TO RELATED APPLICATION

This P.C.T. patent application claims the benefit of and priority to Indian Provisional Patent Application No. 202241074147, filed Dec. 21, 2022, which is incorporated herein by reference in its entirety and for all purposes.

### TECHNICAL FIELD

The present application relates to systems and methods for dynamically determining a mass of a system, such as a vehicle, to enable control of the vehicle, components or systems thereof, and/or for reporting purposes (e.g., to various agencies).

### BACKGROUND

The mass of a vehicle (such as a cargo carrying vehicle like a truck) is often information required for the control and operation of the vehicle. For example, the mass of the vehicle may be used to determine a driving resistance for the vehicle (or load on the vehicle) in order to forecast future action(s) of the vehicle. Further, the mass of the vehicle may be used to develop driver assistance programs as well as manage and control the vehicle. Typically, the mass of a vehicle may be determined or estimated based on grade sensors and load sensors, among potentially other sensors. However, the use of sensors adds cost and complexity to determining the mass of the vehicle. Moreover, sensors can be subject to malfunction and/or tampering thereby leading to inaccuracies in the information from the sensors and/or determinations based on the sensor information. Therefore, systems and methods for estimating the mass of a vehicle without or substantially without the use of certain sensors may be desired.

### SUMMARY

One embodiment relates to a method. The method includes: receiving an indication of a transmission of a vehicle being in a continuously single setting, receiving an indication of a brake event of the vehicle, determining a first energy value regarding the vehicle based on the transmission being in the continuously single setting and the indication of the brake event, receiving an indication of a change in operation of at least one of the transmission and the brake event, determining a second energy value regarding the vehicle based on the indication of the change in operation of the at least one of the transmission and the brake event, based on the first and second energy values, determining a value regarding the vehicle, and controlling operation of a component of the vehicle based on the determined value.

In some implementations, the value is an estimated mass of the vehicle. In some implementations, the first energy value is based on at least one of a first power value regarding operation of the vehicle, a first altitude of the vehicle, or a first speed of the vehicle, and wherein the second energy value is based on at least one of a second power value regarding operation of the vehicle, a second altitude of the vehicle, or a second speed of the vehicle. In some implementations, the first energy value includes the first power value and the second energy value includes the second power value, and wherein the first power value and the second power value are determined without the use of a load sensor. In some implementations, controlling the operation of the component includes controlling the transmission of the vehicle.

Another embodiment relates to a system. The system includes: a controller having one or more processors and one or more memory devices. The one or more memory devices store instructions that, when executed by the one or more processors, cause the one or more processors to perform operations including: receiving an indication of a transmission of a vehicle being in a continuously single setting; receiving an indication of a brake event of the vehicle; determining a first energy value regarding the vehicle based on the transmission being in the continuously single setting and the indication of the brake event; receiving an indication of a change in operation of at least one of the transmission and the brake event; determining a second energy value regarding the vehicle based on the indication of the change in operation of the at least one of the transmission and the brake event; based on the first and second energy values, determining a value regarding the vehicle; and controlling operation of a component of the vehicle based on the determined value.

Still another embodiment relates to a non-transitory computer readable media including instructions stored thereon that, when executed by one or more processors of a processing circuit, cause the one or more processors to perform operations including: receiving an indication of a transmission of a vehicle being in a continuously single setting; receiving an indication of a brake event of the vehicle; determining a first energy value regarding the vehicle based on the transmission being in the continuously single setting and the indication of the brake event; receiving an indication of a change in operation of at least one of the transmission and the brake event; determining a second energy value regarding the vehicle based on the indication of the change in operation of the at least one of the transmission and the brake event; based on the first and second energy values, determining a value regarding the vehicle; and controlling operation of a component of the vehicle based on the determined value.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a schematic diagram of a vehicle having a controller configured to determine the mass of the vehicle, according to an exemplary embodiment.

FIG. 2 is a schematic diagram of the controller of the vehicle of FIG. 1, according to an exemplary embodiment.

FIG. 3 is a flow diagram of a method of determining the mass of a vehicle, according to an exemplary embodiment.

FIG. 4 is a diagram showing a sample period for the vehicle of FIG. 1, according to an exemplary embodiment.

FIG. 5 is a chart showing a mass estimation of the vehicle of FIG. 1, according to an exemplary embodiment.

FIG. 6 is a quadrant filtering method for filtering the mass estimated for the vehicle in FIG. 5, according to an exemplary embodiment.

FIG. 7 is a chart showing a mass estimation of the vehicle of FIG. 1, according to another exemplary embodiment.

### DETAILED DESCRIPTION

Following below are more detailed descriptions of various concepts related to, and implementations of, systems and methods for determining the mass of a vehicle. More specifically, systems and methods for determining the mass of a vehicle in real time or nearly real time during vehicle operation are described herein. The mass determination system and method described herein allows for a relatively more accurate vehicle mass estimation, which may then be broadcasted to vehicle managers, remote operators (e.g., fleet managers), original equipment manufacturers, etc. for vehicle monitoring and control. Further, the mass determination methods and systems described herein allow the mass of the vehicle to be estimated utilizing sensors which may already be in the vehicle without needing additional sensors (e.g., load sensors, grade sensors, etc.) thus reducing the cost and complexity of the systems needed to determine the mass of the vehicle. In some embodiments, at least one sensor may be not utilized compared to traditional methods. In one embodiment, the at least one sensor omitted includes a load sensor. The omission of using load information from a load sensor may reduce vehicle costs, reduce malfunction and/or tampering opportunities, and improve uptime of accurate vehicle mass calculations due to not relying on sensor(s) that could malfunction. In other embodiments, a different sensor or multiple sensors may also be omitted to determine a vehicle mass. Additionally, the mass determination method described herein requires less tuning allowing for the calibration of new vehicles with less level testing. While the term “mass” is used throughout herein, it should be understood that other similar terms may also be used, such as weight.

The various concepts introduced above and discussed in greater detail below may be implemented in any number of ways, as the concepts described are not limited to any particular manner of implementation. Examples of specific implementations and applications are provided primarily for illustrative purposes.

Referring to the Figures generally, various embodiments disclosed herein relate to systems and methods for determining and estimating the mass of a vehicle without the use of certain additional sensors. Typically, the mass of a vehicle is estimated using various sensors on the vehicle by measuring the force and acceleration of the vehicle and then estimating the mass of the vehicle based on Newton's second law (i.e., force=mass×acceleration). However, this typical method of determining the mass of the vehicle incurs costs because of the sensors required. Additionally, the sensors also add complexity to the vehicle systems leading to more maintenance being required for the vehicle. As described herein, only a vehicle velocity and altitude sensor may be utilized via the energy balance methods described herein. Thus, systems and methods for determining the mass of the vehicle without the use of one or more sensors may be desired for fleet efficiency monitoring and optimization to reduce the risk of sensor failure and/or human tampering. The systems and methods described herein determine the mass of the vehicle without the use of certain additional sensors by measuring, estimating, and/or otherwise determining the energy consumed between a first point and a second point and correlating the energy consumed with the mass of the vehicle. After determining or estimating the mass of the vehicle, a controller of the vehicle may control various systems, such as a fueling system to control fuel injection amount that is correlated to a load and mass of the vehicle, a hydraulic system to provide the required power, etc. These and other features and benefits are described more fully herein below.

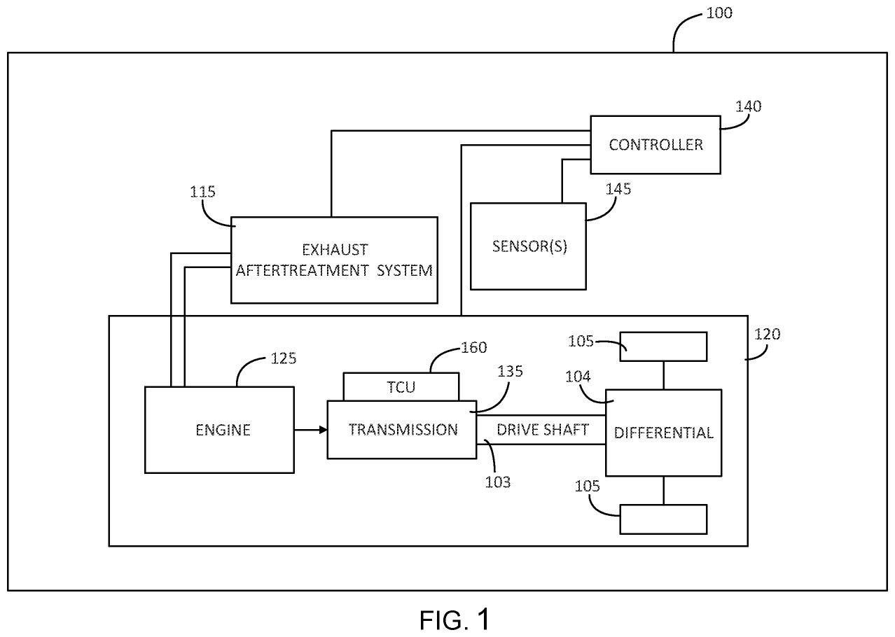

Referring now to FIG. 1, a vehicle 100 is shown, according to an example embodiment. The vehicle 100 may be configured as an on-road or an off-road vehicle (e.g., front end loaders, bulldozers, etc.) including, but not limited to, line-haul trucks, mid-range trucks (e.g., pick-up truck), cars (e.g., sedans), and any other type of vehicle.

The vehicle 100 may be structured as an internal combustion engine driven vehicle (e.g., gasoline, diesel, natural gas or another type of fuel that is combusted and used to power the vehicle), an at least partially hybrid vehicle (e.g., parallel or series hybrid vehicle that includes one or more electric motors and one or more internal combustion engines), a full electric vehicle (e.g., no internal combustion engine), a fuel cell or another alternative energy-driven vehicle, and so on. In the example shown, the vehicle 100 is driven, at least partly, by an internal combustion engine.

The vehicle 100 is shown to include a powertrain system 120 having an internal combustion engine 125. The powertrain system 120 facilitates power transfer from the engine 125 to power and/or propel the vehicle 100. In some embodiments as indicated above, the powertrain system 120 is structured as a conventional non-electrified powered powertrain (e.g., no electric motors powered by one or more batteries or fuel cells to drive the vehicle).

In other embodiments as mentioned above, the powertrain system 120 may be an electric/hybrid powertrain. The powertrain system 120 includes an engine 125 operably coupled to a transmission 135 that is operatively coupled to a drive shaft 103, which is operatively coupled to a differential 104, where the differential 104 transfers power output from the engine 125 to the final drive, which is shown as wheels 105, but may be tracks or other final drives in other embodiments.

If the powertrain system 120 is an electric/hybrid powertrain, it may include one or more electric machines such as a motor and/or motor generator. The electric machine may include a torque assist feature, a regenerative braking energy capture ability, a power generation ability, and any other feature of motor generators used in hybrid vehicles. The electric machine may include a power conditioning device such as an inverter and a motor controller. Further, one or more batteries may be included to provide power to the electric machine(s) and/or store electrical energy for future user.

As a brief overview, the engine 125 receives a chemical energy input (e.g., a fuel such as gasoline or diesel) and combusts the fuel to generate mechanical energy, in the form of a rotating crankshaft. As a result of the power output from the engine 125, the transmission 135 may manipulate the speed of the rotating input shaft (e.g., the crankshaft) to enable a desired drive shaft 103 speed. The rotating drive shaft 103 is received by a differential 104, which provides the rotation energy of the drive shaft 103 to the final drive 105. The final drive 105 then propels or moves the vehicle 100.

The engine 125 may be structured as any internal combustion engine (e.g., compression-ignition or spark-ignition), such that it can be powered by any fuel type (e.g., diesel, hydrogen, ethanol, gasoline, etc.). In the example shown, the engine 125 is structured as a compression-ignition engine that combusts diesel fuel. The transmission 135 may be structured as any type of transmission, such as a manual transmission, an automatic-manual transmission, an automatic transmission (e.g., a dual-clutch transmission, semi-automatic, and other types of automatic transmission), etc. In the example shown, the transmission 135 comprises a plurality of gears or settings and is an automatic transmission, such that shifting may be controlled automatically and without user input by an electronic control unit (e.g., the controller 140 and/or another ECU). Via the plurality of settings or gears, the transmission can affect different output speeds based on the engine speed. The final drive 105 may be structured in any configuration dependent on the application (e.g., the final drive 105 is structured as wheels in an automotive application like as shown with the vehicle 100). Further, the drive shaft 103 may be structured as a one-piece, two-piece, and a slip-in-tube driveshaft based on the application.

The transmission 135 may be operably coupled to a transmission control unit (TCU) 160. The TCU 160 may be communicably coupled to the controller 140 and may receive vehicle information, commands, instructions, etc. from the controller 140. The TCU 160 may be configured to monitor the status of the transmission 135 (e.g., monitor transmission settings) and change the transmission settings (e.g., shift gears) based on information regarding the vehicle 100. The TCU 160 may comprise one or more processing circuits having one or more memory devices coupled to one or more processors. The TCU 160 may at least partly control operation of the transmission 135 including, but not limited to, shifting the transmission from one gear or setting to another gear or setting. The TCU 160 may communicate information regarding the transmission to the controller 140. In some embodiments, the controller 140 may control, at least partly, the transmission 135 in lieu of the TCU 160. In this instance, the TCU 160 may be included with the controller 140.

As also shown, the vehicle 100 includes an exhaust aftertreatment system 115 coupled to and particularly, in fluid communication with, the engine 125. The exhaust aftertreatment system 115 receives exhaust gas from the combustion process in the engine 125 and reduces the emissions from the engine 125 to less environmentally harmful emissions (e.g., reduce the NOx amount, reduce the emitted particulate matter amount, etc.). The exhaust aftertreatment system 115 may include any component used to reduce engine exhaust emissions, such as a selective catalytic reduction catalyst, a diesel oxidation catalyst, a diesel particulate filter, a diesel exhaust fluid doser coupled to a supply of diesel exhaust fluid, a plurality of sensors for monitoring the exhaust aftertreatment system 115 (e.g., a NOx sensor, CO sensor, particulate matter sensors, a greenhouse gas sensor, exhaust gas flow and pressure sensors, ammonia sensors, etc.), a three-way catalyst, an exhaust aftertreatment system heater, etc. It should be understood that other embodiments may exclude an exhaust aftertreatment system and/or include different, less than, and/or additional components than that listed above. Further, the spatial arrangement of the components/systems of the exhaust aftertreatment are highly configurable. All such variations are intended to fall within the spirit and scope of the present disclosure.

The vehicle 100 also includes one or more sensor(s) 145 which may be configured to provide information about the vehicle 100 to the controller 140. In some embodiments, the one or more sensors 145 may include a velocity sensor which is configured to measure or otherwise acquire information indicative of the velocity of the vehicle 100 and send this information to the controller 140. The one or more sensors 145 may further include an altitude sensor which is configured to measure or otherwise receive information indicative of an altitude of the vehicle 100 and send this information to the controller 140. Other sensors 145 may also be included in the vehicle including, but not limited to, temperature sensors (e.g., acquire temperature information regarding operation of the engine and/or another component of the vehicle), cameras (e.g., a back-up camera, front camera, etc.), pressure sensors (e.g., exhaust manifold pressure sensor, etc.), oxygen sensors, power source rotational speed sensor, motive power sensor, and so on. In some embodiments, the sensors may include a clutch sensor which is configured to determine when the clutch is actuated. In some embodiments, the sensors may include a brake sensor which is configured to determine when the brake is actuated (e.g., depressed, at least partly, etc.). For example, the brake sensor may be a Hall Effect sensor or other suitable sensor. The controller 140 may determine the beginning and end of a sample period, as will be explained in more detail below, based on the actuation of the brake and/or clutch as determined by brake sensor and/or the clutch sensor.

The sensors 145 may be real or virtual (i.e., a non-physical sensor that is structured as program logic in the controller 140 that makes various estimations or determinations). For example, an engine speed sensor may be a real or virtual sensor arranged to measure or otherwise acquire data, values, or information indicative of a speed of the engine 125 (typically expressed in revolutions-per-minute). The sensor is coupled to the engine (when structured as a real sensor), and is structured to send a signal to the controller 140 indicative of the speed of the engine 125. When structured as a virtual sensor, at least one input may be used by the controller 140 in an algorithm, model, lookup table, etc. to determine or estimate a parameter of the engine (e.g., power output, etc.). Any of the sensors 145 described herein may be real or virtual.

The controller 140 is coupled to the powertrain 120, the aftertreatment system 115, and the one or more sensors 145. The controller 140 may be structured to control, at least partly, the operation of the vehicle 100. Communication between and among the components may be via any number of wired or wireless connections as described herein with respect to the communications interface 240. Because the controller 140 is communicably coupled to the systems and components in the vehicle 100 of FIG. 1, the controller 140 is structured to receive data (e.g., instructions, commands, signals, values, etc.) from one or more of the components of the vehicle 100 shown in FIG. 1. This may generally be referred to as internal vehicle information (e.g., data, values, etc.). The internal vehicle information represents determined, acquired, predicted, estimated, and/or gathered data regarding one or more components in vehicle 100.

The controller 140 may be configured to determine the mass of the vehicle 100 based on energy the vehicle 100 consumes/utilizes to do work per unit mass of the vehicle 100. More specifically, the controller 140 is configured to receive vehicle operation data, such as a vehicle power, a vehicle velocity, a vehicle altitude, and a motive power source rotational speed from the one or more sensors 145 (alternatively, from a remote source such as from a remote computing system via a network). The controller 140 then uses one or more energy equations based on the vehicle operation data (e.g., vehicle power, the vehicle velocity, the vehicle altitude, and the motive power source rotational speed) to determine the mass of the vehicle.

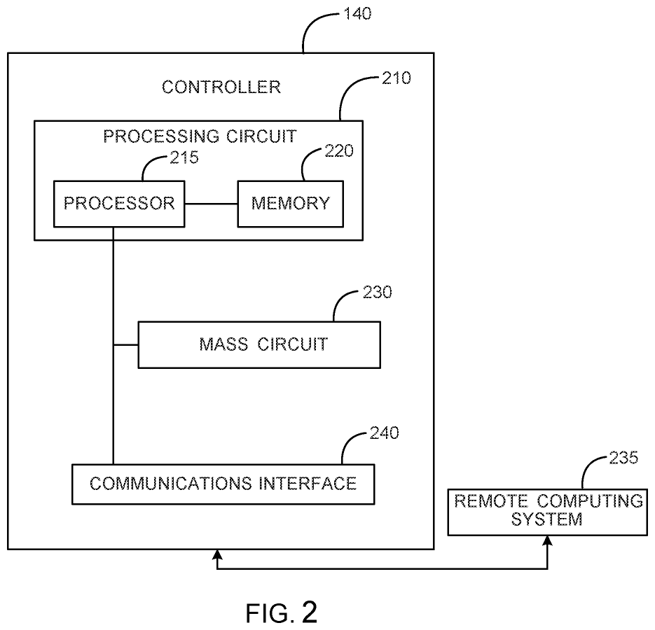

As the components of FIG. 1 are shown to be embodied in a vehicle, the controller 140 may be structured as one or more electronic control units (ECU). The controller 140 may be separate from or included with at least one of the transmission control unit 160, an exhaust aftertreatment control unit, a powertrain control module, an engine control module, etc. In one embodiment, the depicted components of the controller 140 are combined into a single unit. In another embodiment, one or more of the components of the controller 140 (or other controllers not depicted, such as an aftertreatment system controller, etc.) may be geographically dispersed throughout the vehicle (e.g., in separate locations of the vehicle). When there are multiple controllers or components, a datalink (e.g., a J1939 communication network) or CAN bus may connect the multiple controllers to provide shared information. The datalink (or other communication structures) allows the controller 140 to recognize faults, failures, and other information from each of the connected controllers or components. The function and structure of the controller 140 is described in greater detail in FIG. 2. It should be understood that other embodiments may include different, less than, and/or additional components than that described above with respect to the vehicle 100. This depiction is meant to be exemplary, as the systems, methods, and apparatuses may be applicable with a variety of different system configurations.

Referring now to FIG. 2, a schematic diagram of the controller 140 of the vehicle 100 of FIG. 1 coupled to the one or more sensors 145 is shown, according to an example embodiment. In some embodiments, the controller 140 controls the operation of various vehicle components (e.g., the engine 125, the transmission 135, and/or the TCU 160).

As shown in FIG. 2, the controller 140 includes a processing circuit 210 having a processor 215 and a memory or memory device 220. The controller 140 also includes a mass circuit 230, and a communications interface 240. The controller 140 is structured or configured to determine the mass of the vehicle 100.

In one configuration, the mass circuit 230 is embodied as machine or computer-readable media that stores instructions and that is executable by a processor, such as processor 215. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the mass circuit 230 is embodied as one or more hardware units, such as electronic control units. In turn, the mass circuit 230 may be embodied as one or more circuitry components including, but not limited to, processing circuitry, network interfaces, peripheral devices, input devices, output devices, sensors, etc. In some embodiments, the mass circuit 230 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the mass circuit 230 a may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The mass circuit 230 may also include programmable hardware devices such as field programmable gate arrays, programmable array logic, programmable logic devices or the like. The mass circuit 230 may include one or more memory devices for storing instructions that executable by the processor(s) of the mass circuit 230. The one or more memory devices and processor(s) may have the same or similar definition as provided below with respect to the memory device 220 and processor 215. In some hardware unit configurations, components of the mass circuit 230 may be geographically dispersed throughout separate locations in the vehicle. Alternatively and as shown, the mass circuit 230 may be embodied in or within a single unit/housing, which is shown as the controller 140.

In the example shown, the controller 140 includes the processing circuit 210 having the processor 215 and the memory device 220. The processing circuit 210 may be structured or configured to execute or implement the instructions, commands, and/or control processes described herein with respect to the mass circuit 230. The depicted configuration represents the mass circuit 230 as instructions stored in non-transitory machine or computer-readable media. However, as mentioned above, this illustration is not meant to be limiting as the present disclosure contemplates other embodiments the mass circuit 230 is configured as a hardware unit. All such combinations and variations are intended to fall within the scope of the present disclosure.

The processor 215 may be one or more of a single- or multi-chip processor, a digital signal processor (DSP), an application specific integrated circuit (ASIC), a field programmable gate array (FPGA), a programmable logic device, discrete gate or transistor logic, discrete hardware components, another type of suitable processor, or any combination thereof designed to perform at least some of the functions described herein. In this way, the processor 215 may be a microprocessor, a state machine, or other suitable processor. The processor 215 also may be implemented as a combination of computing devices, such as a combination of a DSP and a microprocessor, a plurality of microprocessors, one or more microprocessors in conjunction with a DSP core, or any other such configuration. Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 220 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 220 may be communicably coupled to the processor 215 to provide computer code or instructions to the processor 215 for executing at least some of the processes described herein. Moreover, the memory device 220 may be or include tangible, non-transient volatile memory or non-volatile memory storing instructions that are executable by the processor to perform various operations. Accordingly, the memory device 220 may include database components, object code components, script components, or any other type of information structure for supporting the various activities and information structures described herein.

The mass circuit 230 is structured to receive vehicle information/operation data from the sensors 145. The received vehicle information may include, but is not limited, a vehicle speed, vehicle altitude, a vehicle power (which may be represented by an engine torque and speed), and/or a motive power source rotational speed. The received vehicle information may be from one or more sensors 145 (e.g., engine speed sensor, torque sensor, etc.) and/or other sources (e.g., a remote computing system that provides an altitude of the vehicle). In other embodiments, the mass circuit 230 is structured to determine at least one of a vehicle altitude, a vehicle power output, a vehicle velocity, or a vehicle power source rotational speed, rather than receiving such information from one or more sensors 145 or from a remote source(s). The mass circuit 230 stores one or more equations, tables, and/or algorithms that represent one or more energy balance equations. As described herein, the mass circuit 230 may be configured to determine the mass of the vehicle based on the energy balance equations.

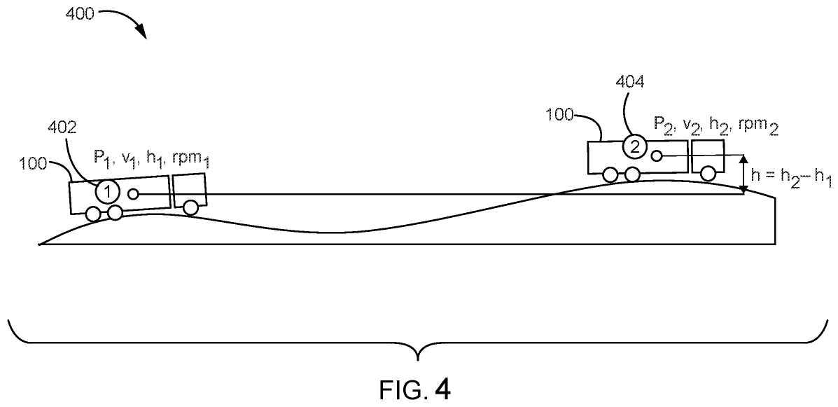

The mass circuit 230 determines or estimates the mass of the vehicle for one or multiple sample periods. A “sample period” refers to operation of the vehicle between a first point and a second point in which the vehicle is continuously operated in one gear or setting without the actuation of a clutch and/or brake pedal. For example and referring now to FIG. 4, an exemplary sample period is shown, according to an exemplary embodiment. As shown in this example, a sample period includes a first point (402), where the instantaneous power (P₁), instantaneous velocity (v₁), instantaneous rotational velocity (rpm₁), and altitude or height (h₁) of the vehicle 100 is measured, received, and/or determined at the first point. The sample period also includes a second point (404), where the instantaneous power (P₂), instantaneous velocity (v₂), instantaneous rotational velocity (rpm₂), and altitude (h₂) of the vehicle 100 is measured, received, and/or determined at the second point. The rotational speed at points one and two, rpm₁ and rpm₂, may be defined as the rotational velocity of a power source. For example, if the power source is an internal combustion engine, then rpm₁ and rpm₂ represent the rotational velocity of the internal combustion engine. As another example, if the power source is an electrical motor, then rpm₁ and rpm₂ represent the rotational velocity of the electrical motor. Therefore, the terms, rpm₁ and rpm₂, are generic terms that may be defined as the rotational velocity of a power source of the vehicle. The mass circuit 230 determines the mass of the vehicle based on one or more energy balance equations for this sample period. Exemplary energy balance equations (1)-(3) are provided below. In the controller, these equations may be represented as one or more look-up tables to facilitate relatively quick continuous or periodic determinations.

$$Work\_done = Supplied\_energy - losses \qquad ( 1 )$$

$$Δ {KE}_{veh} + {W}_{roll} + {W}_{gravity} = {W}_{supply} - {W}_{acc} - {W}_{aero} - {W}_{{drivetrain}_{loss}} - Δ {KE}_{rot} \qquad ( 2 )$$

$${m}_{veh} \cdot ( Work\_per \_ton ) = ( Supplied\_energy - losses ) \qquad ( 3 )$$

In some embodiments, ΔKEᵥₑₕ is the change in kinetic energy of a vehicle from the first point to the second point. ΔKEᵥₑₕ is a function of the mass of the vehicle and the velocity of the vehicle between the first point and the second point. More specifically,

$$Δ {KE}_{veh} = \frac{1}{2} * {m}_{veh} * ( {v}_{2}^{2} - {v}_{1}^{2} ) .$$

In some embodiments, Wᵣₒₗₗ is the work done by the vehicle to roll from the first point to the second point. Wᵣₒₗₗ is a function of vehicle mass, coefficient of rolling friction, acceleration due to gravity and distance travelled from the first point to the second point. In some embodiments, W_{gravity} is the work done on the vehicle to elevate the vehicle from the height at point 1 to the height at point 2. W_{gravity} is a function of the mass of the vehicle, acceleration due to gravity and difference in height between the first point and the second point. In some embodiments, W_{supply} is the energy supplied by the power source between the first point and the second point. W_{supply} may be a summation of instantaneous power supplied between the first point and the second point. W_{acc} is the energy lost due to powering vehicle accessories. W_{acc} may be the summation of instantaneous power supplied to the vehicle accessories between the first point and the second point. In some embodiments, the instantaneous power supplied to the vehicle accessories is calibrated. Wₐₑᵣₒ is the energy loss due to overcome aerodynamic losses. In some embodiments, Wₐₑᵣₒ is function of an aerodynamic drag coefficient, vehicle frontal area, ambient air density, and vehicle velocity. W_{drivetrain}_{ₗₒₛₛ} is the energy lost due to the drivetrain. In some embodiments, the W_{drivetrain}_{ₗₒₛₛ} is a function of a drivetrain loss coefficient, a gear ratio, and a vehicle velocity. In some embodiments, ΔKEᵣₒₜ is the change in rotational kinetic energy of a power source (e.g., engine) between the first point and the second point. In some embodiments, ΔKEᵣₒₜ is a function of rotational moment of inertia and rotational velocity of power source.

The first energy equation (1) equates the work done by the vehicle 100 to the energy supplied to the vehicle minus the energy lost by the vehicle. The work done by the vehicle, Work_done (in kilo-Joules (kJ)), may be determine based on P₁, v₁, h₁, P₂, v₂, and h₂ measured, received, and/or otherwise determined for the sample period. More specifically, the Work_done is in this instance, considered equal to the change in kinetic energy of the vehicle, ΔKEᵥₑₕ (in kJ), plus the rolling work, Wᵣₒₗₗ (in kJ), and the elevation work, W_{gravity} (in kJ), done by the vehicle as shown in the second energy equation (2). Each of the terms in the left-hand side of equation (2) are a function of the mass of the vehicle. Therefore, the mass of the vehicle can be removed from these terms to determine (Work_per_ton). The energy supplied to the vehicle minus the energy lost by the vehicle is further defined in the second energy equation. More specifically, the energy supplied, W_{supply} (in kJ), minus the accessory losses, W_{acc} (in kJ), the aerodynamic losses, Wₐₑᵣₒ (in kJ), the drivetrain losses, W_{drivetrain}_{ₗₒₛₛ} (in kJ), and the motive power kinetic energy change, ΔKEᵣₒₜ (in kJ), equals the Supplied_energy—losses. The third energy equation (3), the work done per ton of the vehicle shown as Work_per_ton, may be calculated or determined for that sample period. It should be understood that these energy balance equations are exemplary. In some embodiments, more or less equations are utilized. Further, in some other embodiments, more or less variables may be added or removed, respectively, from the depicted equations (or other utilized equations). In some embodiments, for each calculation, the Work_per_ton, is stored as an X-vector and the Supplied_energy—losses is stored as a Y-vector since the start of the vehicle (e.g., each key-on event or different “start” designation, etc.). In some embodiments, for every new sample point evaluated, a linear regression analysis through the origin (X=0, Y=0) is performed using a process, such as a RMSE (Root Mean Square Error), for the X-vector containing the Work_per_ton and the Y-vector containing the Supplied_energy—losses, which yields a slope of the values plotted from the X-vector and Y-vector as the mass of vehicle (mᵥₑₕ). In some embodiments, standard error of the slope (mᵥₑₕ) or minimum number of sample points may be used to determine whether the mass of the vehicle can be broadcasted with a confidence above a predefined threshold (i.e., a high confidence threshold).

These energy balance equations may be utilized for a predefined amount of sample periods until sufficient sample periods (more than a predefined threshold) have been evaluated, summed, and averaged, to determine an accurate or relatively accurate mass of the vehicle. In some embodiments, the amount of sample periods needed to calculate an accurate or relatively accurate mass may be a predetermined value (e.g., thirty sample periods, five sample periods, etc.), be based on the length of sample periods, be predetermined based on testing done to determine an accurate mass measurement (e.g., within +/−15% of the actual mass) of the vehicle. In another embodiment, the number of sample periods may be based on a convergence of the determined mass to be within a predefined amount of one or more determinations (i.e., a convergence threshold). For example and with reference to the length of sample periods, relatively longer sample periods may indicate relatively longer periods of time without a shift or a brake event that leads to relatively accurate mass estimations. Energy balance equations (4)-(6) outlined below show the determination of the mass of the vehicle for “n” sample periods, where “n” sample periods are the amount of sample periods used to determine an accurate mass of the vehicle, according to some embodiments.

$${m}_{veh} \_in \_ton \cdot {( Work\_per \_ton )}_{1} = {( Supply\_energy - losses )}_{1}$$

$${m}_{veh} \_in \_ton \cdot {( Work\_per \_ton )}_{2} = {( Supply\_energy - losses )}_{2}$$

$$⋮$$

$${m}_{veh} \_in \_ton \cdot {( Work\_per \_ton )}_{n} = {( Supply\_energy - losses )}_{n} \qquad ( 4 )$$

$$∴ {m}_{veh} \_in \_ton \cdot {\sum }_{n}^{1} Work\_per \_ton = {\sum }_{n}^{1} Supply\_energy - losses \qquad ( 5 )$$

$$∴ {m}_{veh} \_in \_ton = \frac{{\sum }_{n}^{1} Supply\_energy - {losses}_{i}}{{\sum }_{n}^{1} ( Work\_per \_ton ) \_i} \qquad ( 6 )$$

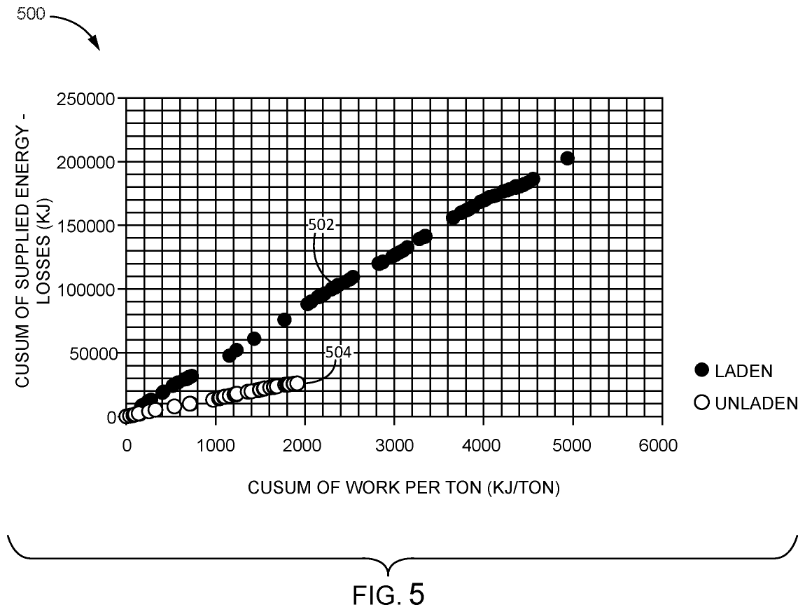

Referring now to FIG. 5, the energy balance equation (5) determinations for a plurality of sample period determinations is shown plotted in chart 500, according to an exemplary embodiment. Chart 500 includes a y-axis which shows the sum of the energy supplied minus the energy lost for “n” sample periods,

$${\sum }_{n}^{1} Supply\_energy - losses .$$

Chart 500 also includes an x-axis which shows the sum of the work done per ton of the vehicle for “n” sample periods,

$${\sum }_{n}^{1} Work\_per \_ton .$$

The laden series 502 and the unladen series 504 show the total energy supplied minus the energy lost against the work done per ton of the vehicle. The laden series 502 shows the energy consumed when the vehicle is carrying a load while the unladen series 504 shows the energy consumed when the vehicle is not carrying a load (or a load below a predefined threshold value). In this example, the sample vehicle for the determinations is a tipper truck (e.g., a dump truck). In some embodiments, certain combinations of the

$${\sum }_{n}^{1} Supply\_energy - losses and {\sum }_{n}^{1} Work\_per \_ton$$

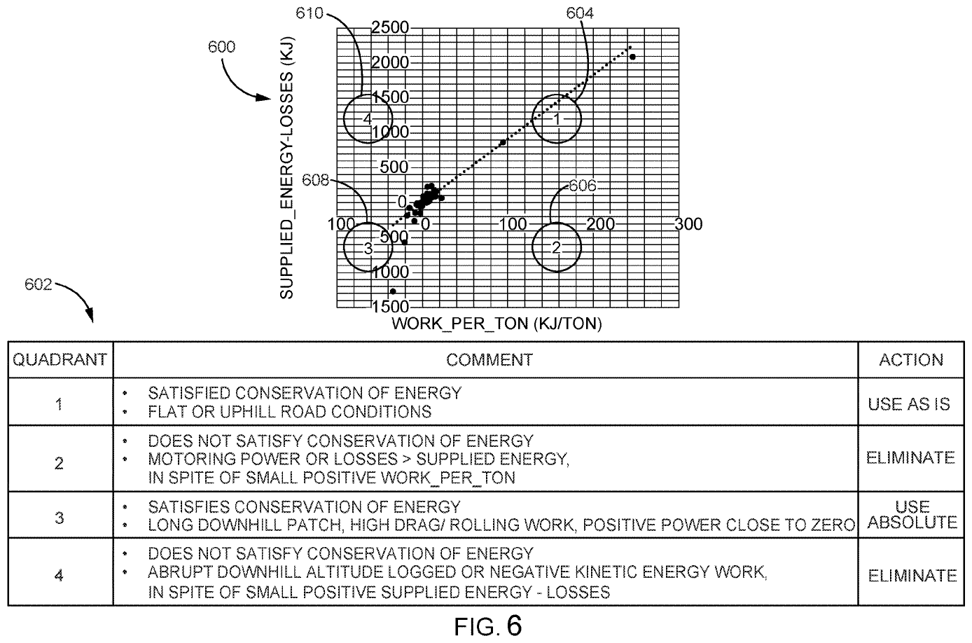

may be filtered out because these combinations do not satisfy one or more constraints, such as a conservation of energy constraint. Specifically, the combinations may be filtered by a quadrant filtering technique or process according to an example embodiment. The quadrant filtering technique is applied to data to remove or modify the data. The quadrant filtering technique refers to a data filtering technique which filters plotted data based on the quadrant the data is plotted in. The quadrant filtering technique is explained in more detail below with respect to FIG. 6. Referring now to FIG. 6, a chart 600 plotting data which may be filtered via the quadrant filtering technique described herein is shown, according to an exemplary embodiment. FIG. 6 depicts a graph 600 which plots the energy balance equation (5) for a plurality of sample periods. The y-axis of graph 600 represents the energy supplied minus the energy lost for multiple sample periods. The x-axis of graph 600 represents the work done per ton of the vehicle for multiple sample periods. The multiple sample periods plotted on graph 600 are categorized based on the quadrant (e.g., first quadrant 604, second quadrant 606, third quadrant 608, and fourth quadrant 610). Table 602 describes the quadrant filtering technique for each of the multiple sample periods based on the quadrant in which they fall. For example, the sample periods which fall within the second and fourth quadrant 606 and 610, respectively, may be eliminated because they do not satisfy a constraint, such as the law of the conservation of energy. More specifically, in the second quadrant 606, the motoring power or losses is above the supplied energy in spite of the low amount of positive work done per ton of the vehicle. Therefore, these samples do not or likely do not satisfy the conservation of energy. Additionally, in the fourth quadrant 610, an abrupt downhill altitude logged (downhill grade more than a predefined amount) or negative kinetic energy work (beyond a threshold value) in spite of small positive supplied energy minus losses indicates that the samples collected in this quadrant do not or likely do not satisfy the conservation of energy. As another example, the sample periods which fall within the first quadrant 604, which may be collected during flat or uphill road conditions (road grades within a predefined flat grade threshold or above an uphill grade threshold), may be used as-is because they are deemed to satisfy the law of the conservation of energy. As yet another example, the sample periods which fall within the third quadrant 608, which may be collected during long downhill road conditions leading to high drag and the positive power being close to zero (below a predefined low power value), may also be deemed to satisfy the law of the conservation of energy. However, since the values at those sample periods are negative, their absolute value may be used by the controller to determine the mass of the vehicle.

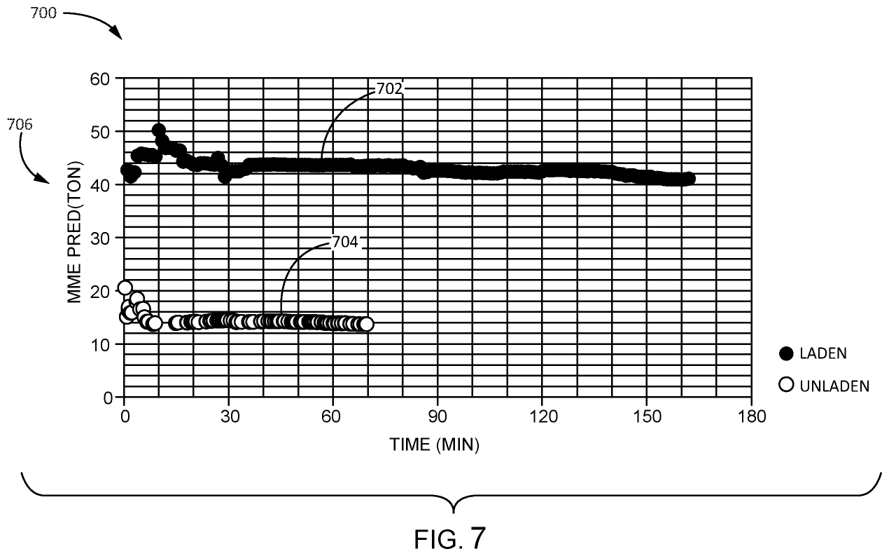

Referring now to FIG. 7, the energy balance equation (6) for a plurality of samples is shown plotted in chart 700, according to an exemplary embodiment. The y-axis of chart 700 represents the ratio 706 of the sum of the energy supplied minus the energy lost for n sample periods,

$${\sum }_{n}^{1} Supply\_energy - losses$$

and the sum of the work done per ton of the vehicle for n sample periods,

$${\sum }_{n}^{1} Work\_per \_ton .$$

The x-axis represents time. In this example embodiment, the ratio 706 is equal to the mass of the vehicle. The laden series 702 and the unladen series 704 depict the mass of the vehicle as a function of time. The laden series 702 shows the mass of the vehicle when the vehicle is carrying a load (above a predefined threshold, which may be an absolute value, a percentage of the vehicle, or another indicator) while the unladen series 704 shows the mass of the vehicle when the vehicle is not carrying a load or a load below a predefined value for a given vehicle.

The mass circuit 230 is structured to determine when a confidence threshold is satisfied regarding the estimated mass (which may be over multiple sample period determinations) and to broadcast or communicate, or cause a broadcast or a communication via the communications interface 240, of the estimated mass of the vehicle 100 in response to confidence threshold being satisfied. The “confidence threshold” refers to a threshold, level, or other gauge used to determine the accuracy of the determined or estimated vehicle mass. When the confidence threshold is met or exceeded, the controller 140 (mass circuit 230) determines that the estimated or determined vehicle mass is likely accurate or substantially accurate (e.g., within a predefined amount of the actual mass). In some embodiments, the confidence threshold is determined based on when the amount of sample periods collected and evaluated passes a certain threshold. In some embodiments, the confidence threshold is based on the number of sample periods surpassing a predefined threshold. In some embodiments, the confidence threshold is based on a distance traveled by the vehicle 100 for the sample periods exceeding a predefined threshold. In some embodiments, the confidence threshold is based on

$${\sum }_{n}^{1} Supply\_energy - losses$$

being above a predefined threshold. In some embodiments, the confidence threshold is based on

$${\sum }_{n}^{1} Work\_per \_ton$$

being above a predefined threshold. When the mass circuit 230 determines that the confidence threshold has been met or exceeded, the communications interface 240 sends the estimated mass value of the vehicle as determined by the mass circuit 230 to one or more vehicle components (e.g., such as the TCU 160) or external sources (e.g., the remote computing system).

The communications interface 240 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and out-of-vehicle communications (e.g., with a remote server). For example and regarding out-of-vehicle/system communications, the communications interface 240 may include an Ethernet card and port for sending and receiving data via an Ethernet-based communications network and/or a Wi-Fi transceiver for communicating via a wireless communications network. The communications interface 240 may be structured to communicate via local area networks or wide area networks (e.g., the Internet) and may use a variety of communications protocols (e.g., IP, LON, Bluetooth, ZigBee, radio, cellular, near field communication). In some embodiments, out-of-vehicle communications may be provided via a telematics unit such that the communications interface may be incapable of out-of-vehicle communications.

The communications interface 240 may facilitate communication between and among the controller 140 and one or more components of the vehicle 100 (e.g., the engine 125, the transmission 135, the TCU 160, the aftertreatment system 115, the sensors 145 etc.). Communication between and among the controller 140 and the components of the vehicle 100 may be via any number of wired or wireless connections (e.g., any standard under IEEE). For example, a wired connection may include a serial cable, a fiber optic cable, a CAT5 cable, or any other form of wired connection. In comparison, a wireless connection may include the Internet, Wi-Fi, cellular, Bluetooth, ZigBee, radio, etc. In one embodiment, a controller area network (CAN) bus provides the exchange of signals, information, and/or data. The CAN bus can include any number of wired and wireless connections that provide the exchange of signals, information, and/or data. The CAN bus may include a local area network (LAN), or a wide area network (WAN), or the connection may be made to an external computer (for example, through the Internet using an Internet Service Provider).

In some embodiments, the controller 140 is coupled to a remote computing system 235 (e.g., a server or cloud-based computing system) whereby one or more of the processes discussed herein is accomplished in one or more processors of the remote computing system 235. The remote computing system 235 may be associated with, managed by, owned by, and/or otherwise controlled by a vehicle manufacturer, a vehicle system or component manufacturer (e.g., an OEM), a fleet manager for multiple vehicles, an agency (e.g., a government agency for tracking emissions and fleet operations, etc.), and/or another entity. The remote computing system 235 may include one or more processing circuits having one or more processors coupled to one or more memory devices, one or more communications interfaces for communicating with one or more vehicles and other computing systems, and other suitable hardware and program logic. The remote computing system 235 may be configured as a backend server system, a cloud computing system, and/or other suitable computing system. The remote computing system 235 may be configured or structured to perform various operations.

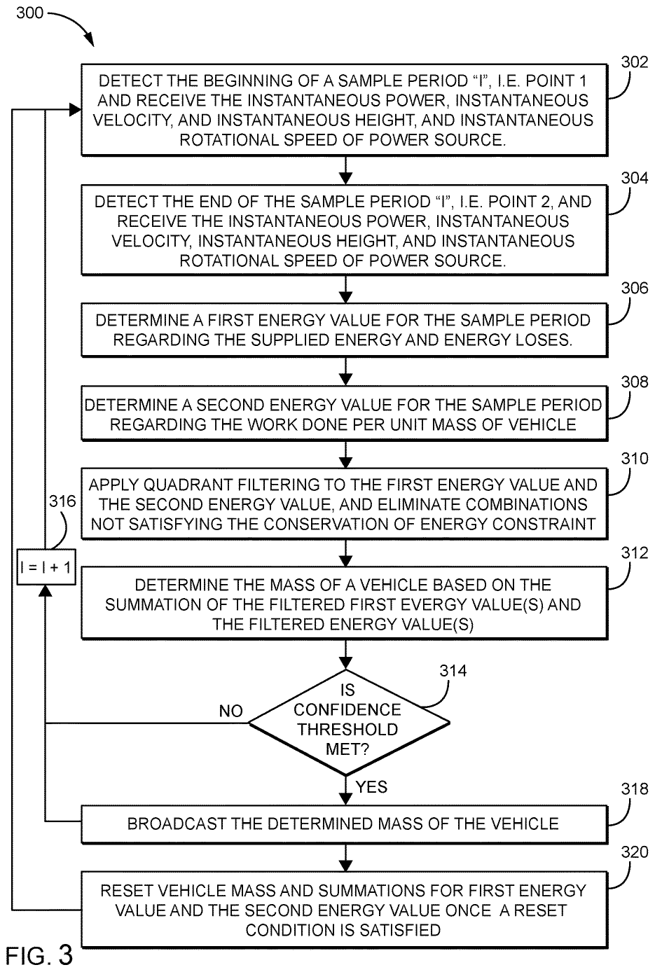

Referring now to FIG. 3, a method 300 of calculating, estimating, and/or otherwise determining the mass of a vehicle is shown, according to an example embodiment. In some embodiments, the method 300 may determine the mass of the vehicle based on one or more energy balance equations without the use of certain additional sensors, such as a load sensor or grade sensor. In some embodiments, the method 300 may be performed by the controller 140. In some other embodiments, one or more processes may be performed by the remote computing system 235 in combination with the controller 140.

The method 300 begins at process 302 with the controller 140 detecting the beginning of a sample period. The controller 140 may receive an indication of a transmission of a vehicle being in a continuously single setting and/or receive an indication of a brake event of the vehicle. The brake event may be non-actuation (non-depression) of the brake pedal (a first brake event). The brake event may also be actuation (depression) of the brake pedal (a second brake event). As described above with respect to FIG. 4, a sample period is defined as a vehicle event where the vehicle operates between a first point and a second point in which the vehicle is continuously operated in one transmission setting or gear, without the actuation of a clutch and/or brake pedal. For example, the TCU or controller 140 identifies a setting existing for a predefined amount of time (e.g., five seconds). The controller 140 then detects no actuation of a brake and/or clutch, via the brake and/or clutch sensors, for a predefined amount of time (e.g., three seconds, five second, seven seconds, etc.). At which point, the controller 140 determines the initiation of a sample period. Therefore, at process 302, the controller 140 determines the beginning of a sample period “i” (where i=1) at point 1. Based on the determined initiation of the sample period, the controller 140 determines a first energy value regarding the vehicle based on the transmission being in the continuously single setting and the indication of the brake event. In some embodiments, the controller 140 receives an indication of a brake event for the vehicle 100 using a vehicle velocity sensor. The energy value may be based on the vehicle operation data (e.g., an instantaneous power, an instantaneous velocity, an instantaneous rotational speed of a power source (e.g., engine and/or electric motor), and/or an instantaneous height or altitude) of the vehicle 100, which is shown at point 402 in FIG. 4. This information may be received from the remote computing system 235 and/or determined via one or more sensors (e.g., engine torque and speed sensors, altitude sensors, etc.). In some embodiments, first energy value is determined based on data received from at least one of the vehicle velocity sensor, an altitude sensor, and a rotational velocity sensor for a power source for moving the vehicle.

At process 304, the controller 140 determines the end of the sample period at point 2 (point 2 of the first sample period, i=1). The end of the sample period may be determined based on the controller 140 receiving an indication of a change in operation of at least one of the transmission and the brake event (in this instance, the second brake event mentioned above; in other embodiments, the indication may be the change in operation of the transmission; in still other embodiments, the indication may be both data points). At the second point, subsequent vehicle operation data (e.g., the instantaneous power, instantaneous velocity, an instantaneous rotational speed of a power source (e.g., engine and/or electric motor), and/or instantaneous height of the vehicle 100) is determined, which is shown at the end of the sample period, 404, in FIG. 4. These values may be determined similarly to the values at the start of the sample period described above. The second point may be determined at a moment in time immediately preceding a clutch and/or brake pedal being actuated. Alternatively, the second point may be a predefined amount of time after the first point and without the brake and/or clutch pedal being actuated (and the transmission staying in the same gear or setting).

At process 306, the controller 140 calculates, estimates, and/or otherwise determines a first energy value for the sample period “i” (in this first instance, i=1). The first energy value may be the amount of energy supplied to the vehicle minus the energy lost by the vehicle as the vehicle moves as described in energy balance equation (1). More specifically, in some embodiments, the controller 140 determines the amount of energy supplied to the vehicle minus the energy lost by the vehicle based on the instantaneous power, instantaneous velocity, instantaneous height, and instantaneous rotational speed of power source measured or otherwise determined at the beginning and at the end of the sample period, with such information being received at processes 302 and 304. At process 308, the controller 140 calculates, estimates, and/or otherwise determines a second energy value for the sample period “i”. The second energy value may be the work done per ton of the vehicle as described in the energy balance equation (3). More specifically, in some embodiments, the controller 140 determines the work done per ton of the vehicle based on the vehicle operation data (e.g., instantaneous power, instantaneous velocity, instantaneous height, and/or instantaneous rotational speed of power source) measured at the beginning and at end of the sample period. The energy supplied to the vehicle minus the energy lost, needed per unit work per ton may be used to estimate or determine a value regarding the vehicle, such as the mass of the vehicle.

At process 310, the controller 140 generates a data graph with the first energy value and the second energy value where the amount of energy supplied to the vehicle minus the energy lost by the vehicle is plotted on the y-axis while work done per ton of the vehicle is plotted on the x-axis. In other embodiments, a plot may not be generated; rather, the equations may be retrieved and executed by the controller 140 (e.g., via a look-up table and/or other mechanisms). Once the data graph or the values otherwise generated and in some embodiments, the controller 140 applies a filtering process. In particular, the controller 140 utilizes a quadrant filtering process to the data values within the graph. As described above, table 602 describes the quadrant filtering process for each of the energy values for each of the multiple sample periods based on the quadrant in which they fall. The quadrant filtering technique may reduce or eliminate combinations of the first energy value and the second energy value which do not satisfy the conservation of energy constraint.

At process 312, the controller 140 calculates, estimates, or otherwise determines the mass of a vehicle based on the summation of the filtered first energy value(s) and the filtered second energy value(s) as described above with respect to equations (4)-(6). In some embodiments, the first and second energy values are not filtered. At process 314, the controller 140 determines whether confidence threshold has been met. As described above, the confidence threshold refers to a standard, level, threshold, or other indicator used to assess the accuracy of the determined mass. In some embodiments, the confidence threshold is based on the amount of sample periods. In some embodiments, the confidence threshold is based on a distance traveled by the vehicle 100 for the sample periods. The greater the distance traveled for the sample periods indicates several sample periods, which may lead to a relatively more accurate determination. In some embodiments, the confidence threshold is based on

$${\sum }_{n}^{1} Supply\_energy - losses$$

being above a certain predefined threshold. In some embodiments, the confidence threshold is based on

$${\sum }_{n}^{1} Work\_per \_ton$$

being above a certain predefined threshold. If the confidence threshold has not been met, then the method proceeds to process 316 where “i” is incremented and another sample period is evaluated starting at process 302 (i=2, i=3, and so on). If the confidence threshold has been met, then the method proceeds to process 318. At process 318, the controller 140 broadcasts the calculated mass of the vehicle 100 to, for example, the remote computing system 235. After broadcasting the calculated or determined mass, the method proceeds to process 316, and keeps incrementing sample periods at process 302 and keeps updating calculated mass, as more data is collected. That way, over time, the accuracy of the mass determination may improve.

At process 320, the controller 140 resets the vehicle mass and summations for the first energy value and the second energy value once a reset condition is satisfied. As described above, the processes 302-318 may be repeated multiple times until a confidence threshold has been met thus producing multiple first energy values and second energy values. Once the confidence threshold is met, the determined mass of the vehicle keeps updating and broadcasting at processes 314-318. The vehicle mass and summations for the first energy values and second energy values may be reset at process 320. One or more of a plurality of reset conditions may be utilized. Example reset conditions include, but are not limited, any one or more of the following: the vehicle engine being shut down for a period longer than a certain predefined time threshold (e.g., based on a timer implemented within the controller 140); the vehicle engine idling for a period longer than a certain predefined time threshold; the vehicle not being in motion for a period longer than a certain predefined threshold (e.g., based on accelerometers positioned at or near the final drive to detect movement of the vehicle, based on GPS coordinates of the vehicle indicating no movement, etc.); and/or, the difference in the high confidence vehicle estimated mass before and after one of a vehicle engine shutdown, a vehicle engine idling, and/or a vehicle not being in motion being greater than a mass threshold. The last condition refers to a difference of the value regarding the vehicle (e.g., estimated mass) at an instance before and at an instance after the at least one of the engine shutdown time being greater than the first time threshold, the engine idling time being longer than the second time threshold, and/or the vehicle not being in motion for the time period exceeding the third time threshold being greater than a threshold value. Thus, if the high confidence vehicle mass estimate decreases or increases by more than a threshold amount after any of the aforementioned conditions (e.g., a before and after), this indication may be the reset condition itself. Subsequent to the reset condition(s) being detected, determined, and/or otherwise received, the process may reset to estimate a new vehicle mass at process 302.

In some embodiments, the controller 140 may control one or more components of the vehicle based on the estimated mass of the vehicle as determined by the controller. For example, the controller 140 may implement one or more gear shifts based on the estimated mass in order to account for the mass load and improve fuel economy. As an example, higher mass values may trigger usage of a different transmission shift schedule than lower mass values, where the transmission shift schedules may be structured to improve fuel economy. The shifts may be implemented automatically (e.g., with an automatic transmission) and/or an indication provided via an input/output device (e.g., display) to either show the operator the change (for automatic transmissions) or prompt the operator to do the determined shift (e.g., with manual or automatic-manual transmissions). As another example, the controller 140 may broadcast the estimated mass of the vehicle to the remote computing system 235. The remote computing system 235 may use the estimated mass of the vehicle to monitor a fleet of vehicles, determine vehicle usage patterns, and/or determine service intervals for one or more vehicles in the fleet. The remote computing may also use the estimated mass of the vehicle to command drafting arrangements for the vehicle relative to other vehicles in the fleet to improve fuel economy and accomplish fleet operational objectives. As another example, the controller 140 may control the torque of the engine 125 based on the estimated mass of the vehicle to improve fuel economy. As another example, the controller 140 may control the vehicle to limit the maximum acceleration based on the estimated mass of the vehicle to improve fuel economy.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It should be understood that the controller 140 may include any number of circuits for completing the functions described herein. Additional circuits with additional functionality may also be included. Further, the controller 140 may further control other activity beyond the scope of the present disclosure.

As mentioned above and in one configuration, the “circuits” may be implemented in machine-readable medium storing instructions for execution by various types of processors, such as the processor 215 of FIG. 2. Executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object-oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Likewise, software implementations of the described methods may be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A method, comprising:
receiving an indication of a transmission of a vehicle being in a continuously single setting;
receiving an indication of a brake event of the vehicle;
determining a first energy value regarding the vehicle based on the transmission being in the continuously single setting and the indication of the brake event;
receiving an indication of a change in operation of at least one of the transmission and the brake event;
determining a second energy value regarding the vehicle based on the indication of the change in operation of the at least one of the transmission and the brake event;
based on the first and second energy values, determining a value regarding the vehicle; and
controlling operation of a component of the vehicle based on the determined value.

2. The method of claim 1, wherein the determined value is an estimated mass of the vehicle.

3. The method of claim 1, wherein the first energy value is indicative of an amount of energy supplied to vehicle minus energy lost by the vehicle during movement of the vehicle, and wherein the second energy value is indicative of a work done per ton of the vehicle during movement of the vehicle.

4. The method of claim 3, wherein the first energy value is based on at least one of a power supplied by a power source, a vehicle velocity and a change in rotational speed of the power source during movement of the vehicle, and wherein the second energy value is based on at least one of a change in vehicle velocity, a distance travelled and a change in altitude during movement of the vehicle.

5. The method of claim 4, further comprising filtering the first and second energy values based on a conservation of energy constraint.

6. The method of claim 1, wherein the determined value is an estimated mass of the vehicle, and wherein the determined value is determined without the use of a load sensor.

7. The method of claim 1, wherein controlling the operation of the component includes controlling the transmission or torque of a power source of the vehicle.

8. The method of claim 1, wherein the determined value is based on a summation of a plurality of first energy values and a summation of a plurality of second energy values of multiple samples collected since a reset condition was satisfied.

9. The method of claim 8, wherein the reset condition is at least one of an engine shutdown time being greater than a first time threshold, an engine idling time being longer than a second time threshold, and the vehicle not being in motion for a time period exceeding a third time threshold.

10. The method of claim 9, wherein the reset condition is a difference of the value regarding the vehicle at an instance before and at an instance after the at least one of the engine shutdown time being greater than the first time threshold, the engine idling time being longer than the second time threshold, and the vehicle not being in motion for the time period exceeding the third time threshold being greater than a threshold value.

11. A system comprising:
a controller comprising one or more processors and one or more memory devices storing instructions that, when executed by the one or more processors, cause the one or more processors to perform operations including:
receiving an indication of a transmission of a vehicle being in a continuously single setting;
receiving an indication of a brake event of the vehicle;
determining a first energy value regarding the vehicle based on the transmission being in the continuously single setting and the indication of the brake event;
receiving an indication of a change in operation of at least one of the transmission and the brake event;
determining a second energy value regarding the vehicle based on the indication of the change in operation of the at least one of the transmission and the brake event;
based on the first and second energy values, determining a value regarding the vehicle; and
controlling operation of a component of the vehicle based on the determined value.

12. The system of claim 11, wherein the first energy value is indicative of an amount of energy supplied to vehicle minus energy lost by the vehicle during movement of the vehicle, and wherein the second energy value is indicative of a work done per ton of the vehicle during movement of the vehicle.

13. The system of claim 12, wherein the first energy value is based on at least one of a power supplied by a power source, a vehicle velocity and a change in rotational speed of the power source during movement of the vehicle, and wherein the second energy value is based on at least one of a change in vehicle velocity, a distance travelled and a change in altitude during movement of the vehicle.

14. The system of claim 13, wherein the instructions, when executed by the one or more processors, further cause the one or more processors to perform operations including filtering the first and second energy values based on a conservation of energy constraint.

15. The system of claim 11, wherein the determined value is an estimated mass of the vehicle, and wherein the determined value is determined without the use of a load sensor.

16. The system of claim 11, wherein controlling the operation of the component includes controlling the transmission or torque of a power source of the vehicle.

17. The system of claim 11, wherein the determined value is based on a summation of a plurality of first energy values and a summation of a plurality of second energy values of multiple samples collected since a reset condition was satisfied.

18. A non-transitory computer readable media comprising instructions stored thereon that, when executed by one or more processors of a processing circuit, cause the one or more processors to perform operations including:
receiving an indication of a transmission of a vehicle being in a continuously single setting;
receiving an indication of a brake event of the vehicle;
determining a first energy value regarding the vehicle based on the transmission being in the continuously single setting and the indication of the brake event;
receiving an indication of a change in operation of at least one of the transmission and the brake event;
determining a second energy value regarding the vehicle based on the indication of the change in operation of the at least one of the transmission and the brake event;
based on the first and second energy values, determining a value regarding the vehicle; and
controlling operation of a component of the vehicle based on the determined value.

19. The non-transitory computer readable media of claim of claim 18, wherein the first energy value is indicative of an amount of energy supplied to vehicle minus energy lost by the vehicle during movement of the vehicle, and wherein the second energy value is indicative of a work done per ton of the vehicle during movement of the vehicle.

20. The non-transitory computer readable media of claim of claim 19, wherein the first energy value is based on at least one of a power supplied by a power source, a vehicle velocity and a change in rotational speed of the power source during movement of the vehicle, and wherein the second energy value is based on at least one of a change in vehicle velocity, a distance travelled and a change in altitude during movement of the vehicle.
